(19) United States
(12) Patent Application Publication
(10) Pub. No.: US 2025/0242510 A1
(43) Pub. Date: Jul. 31, 2025

(54) DERMAPLANE RAZOR

(71) Applicant: Harry's, Inc., New York, NY (US)

(72) Inventors: James PARMELE, Brooklyn, NY (US); Richard TANAKA, Astoria, NY (US)

(21) Appl. No.: 18/429,075

(22) Filed: Jan. 31, 2024

(51) Int. Cl. B26B 21/10; B26B 21/40; B26B 21/52

(52) U.S. Cl. CPC B26B 21/10; B26B 21/4037; B26B 21/4043; B26B 21/521; B26B 21/522

(57) ABSTRACT

A non-disposable dermaplane razor having a main body, including a handle portion and a cartridge retention portion, a replaceable blade cartridge and, optionally, a removable cover. The cartridge retention portion has a cartridge opening comprising a T-shape having an upper portion and a stem portion extending longitudinally inward from a front face to receive the blade cartridge with an open slot at the bottom of the stem portion, the cartridge including a spine comprising an I-shape with the top horizontal portion and vertical middle portion of the I-shape corresponding to the upper portion and stem portion of the T-shape of the opening, and the bottom horizontal portion of the I-shape extending beyond the slot.

### FIELD OF THE INVENTION

The present invention relates to the field of razors, and more specifically to a dermaplane razor.

### BACKGROUND OF THE INVENTION

Dermaplaning has become a popular, non-invasive beauty treatment, where a sharp tool, such as a razor, is used to exfoliate the surface of the skin, as well as to remove fine hairs. This treatment is often performed on clients by trained technicians, however, dermaplaning can also be performed by a person on themselves.

Basically, the technician or user gently scrapes the skin with the razor to remove dead skin and unwanted hair. This is intended to result in the removal of imperfections in the skin and overall smoother skin.

Specialized dermatomes and dermaplane razors have been developed as tools to assist in the practice of dermaplaning. Dermatomes are electric devices, which often look like electric razors, having blades which move back and forth over the skin to exfoliate the top layer of the skin. Dermaplane razors, on the other hand, are manually operated and generally resemble a scalpel, with a single razor blade at one end that can be manipulated by a handle on the other end.

Variations of dermaplane razors include disposable and non-disposable dermaplane razors. Disposable dermaplane razors have a razor blade securely and non-releasably affixed to a main body having a handle. Once the blade becomes dull, the user will dispose of the device and begin using a new one with a sharp blade.

Non-disposable dermaplane razors generally have replaceable razor blades that can be removed from the main body of the tool and replaced with a new razor blade. Because the blades of non-disposable dermaplane razors can be replaced, a non-disposable dermaplane razor can be made more substantial, i.e., more structurally solid, and easier to control than a disposable dermaplane razor that is thrown away once the blade becomes dull.

Notwithstanding, there are deficiencies in the current non-disposable dermaplane razors, where blade replacement on the main body of the tool and overall control of the tool can be improved.

### SUMMARY OF THE INVENTION

The present invention is directed to a non-disposable dermaplane razor comprising a main body, including a handle portion and a cartridge retention portion, a replaceable blade cartridge, and a removable cover. The cartridge retention portion comprises a cartridge opening extending longitudinally inward from a front face of the cartridge retention portion to receive the blade cartridge.

The blade cartridge comprises a blade with a cutting edge fixed within a quasi-triangular I-shaped spine, the blade extending from the bottom of the I-shape when the cutting edge of the blade is facing downward. The spine includes a detent on the top edge for friction engagement with the top of the cartridge opening of the main body when the cartridge is fully inserted into the main body. The spine terminates in a graspable end, preferably having recesses on one or both of the sides to be engaged by the user's fingers for removal during replacement of the cartridge on the main body of the dermaplane razor.

The main body preferably comprises a non-slip outer surface on at least a portion of the handle portion and a non-slip grip pad on a top edge of the main body for improved control of the dermaplane razor. The non-slip outer surface and grip pad are preferably formed of a silicone or similar increased friction material, designed to limit the dermaplane razor from slipping in the user's hand during use.

A preferred embodiment is made from a diecast main body running from the handle portion to the cartridge retention portion, with the cartridge retention portion extending at an obtuse angle from the handle portion for ease of use. The diecast main body is cast from a metal or plastic material, or combinations thereof, with the handle portion preferably molded to include friction features for engaging with the internal surface of an outer sleeve made from a non-slip material.

The non-slip outer surface of the handle portion can be molded directly onto the main body, or the handle portion of the main body itself can be molded from a non-slip material. However, it is preferred that the main body has an outer sleeve made of a thermoplastic elastomer, preferably having internal features that engage the friction features on the handle portion of the main body, thereby ensuring the outer sleeve is securely fastened on the main body.

The grip pad can be a gnarled surface on a portion of the main body, an indent on the surface of the main body or another area that enhances control of the dermaplane razor. The grip pad is preferably located on a top surface of the main body, in the area on the handle portion adjacent the angle between the handle portion and the cartridge retention portion. In a preferred embodiment, the grip pad also provides a visual and tactile cue to the user for how to hold the dermaplane razor.

In a preferred embodiment, the main body comprises an aperture, for receiving a grip pad formed of a material different than the main body, and preferably a TPE. Such a grip pad can be molded directly within the aperture or, preferably, formed separate from the main body and press fit into the aperture. In a preferred embodiment, the surface of the grip pad is even with the top surface of the main body so as to provide a smooth top surface, but a grip pad that extends either above or below the surface of the main body may be used, as desired.

The cartridge retention portion of the main body comprises a cartridge opening at the front end for receiving the cartridge, with a slot along the bottom of at least a portion of the cartridge retention portion through which the blade extends. The cartridge opening geometry is the same as at least a portion of the cartridge geometry, with a tight clearance along the full length of the cartridge to provide stability during use.

In a preferred embodiment, the geometry of the cartridge opening has a quasi-triangular T-shape profile corresponding to the top horizontal and middle vertical portions of the I-shape cartridge. The vertical portion of the T-shape opening is preferably thinner near the bottom than the top, corresponding to the middle portion of the preferred I-shape spine, and conforming to a thinner bottom portion of the cartridge retention portion. The thinner bottom allows the user to get the blade closer to the skin, while the thicker top portion provides additional structural support for the cartridge.

The cartridge preferably comprises a blade having a blade guard across the cutting edge of the blade, as known in the art to improve safety when using the dermaplane razor, set in a spine having a shape that conforms to the cartridge opening. It is preferred that the spine has a quasi-triangular I-shape profile, with the horizontal bottom portion of the I-shape residing below the bottom of the T-shape of the cartridge opening.

At least a portion of the I-shape spine is preferably thicker at the top and thinner at the bottom where the blade projects, most preferably with at least a portion of the vertical portion of the I-shape and at least a portion of the sides of the bottom horizontal portion of the I-shape angling inward toward the bottom where the blade extends. This aids in allowing the user to get the blade closer to the skin when using the razor.

The top side of the top horizontal portion of the I-shape spine includes at least one interference detent to provide a friction hold when the cartridge is fully inserted within the cartridge opening of the main body. The detent not only holds the cartridge in the cartridge opening, but forces the faces of the cartridge into engagement with the surfaces of the opening to stabilize the cartridge in the main body.

More particularly, when the quasi-triangular I-shaped spine is inserted into the corresponding cartridge opening the detent on the top of the spine engages the top of the cartridge opening to put downward pressure on the spine when fully inserted. The detent preferably compresses somewhat against the top surface of the cartridge opening, forcing the bottom of the top horizontal portion of the I-shape of the spine, and preferably the angled middle vertical portion of the I-shape of the spine, into tight contact with the corresponding portions of the cartridge opening to provide a secure retention of the cartridge during use. This creates an increased security between the cartridge and main body, significantly reducing if not eliminating rotation of the cartridge and rigidity along the length of the blade when the cartridge is fully inserted into the cartridge opening of the main body.

The spine preferably terminates at a graspable end, opposite an insertion end, for removal of the cartridge from the main body. The graspable end, preferably formed of the same material and formed integrally with the spine, comprises recesses on one or both sides for the user to engage with their fingertips, aiding in removal of the cartridge. The recesses allow the user to interact with the cartridge without putting their hands close to the blade, with the contours of the recesses allowing for an easier, firmer grip on the cartridge and a clearer visual cue to the user.

The detent is preferably located closer to the graspable end than the insertion end of the cartridge so that it engages the top surface of the cartridge opening when the cartridge is almost fully inserted. The location of the detent means that the user will not feel any interference until the cartridge is almost fully inserted into the main body, providing the user with a positive tactile confirmation of engagement when the cartridge is nearly fully inserted.

A preferred embodiment further comprises a cover for protecting the blade and user during storage and transportation. A preferred cover encloses the entire blade of a cartridge inserted into cartridge opening and at least a portion of the cartridge connection portion of the main body. The interior of the top of the cover preferably includes a stop feature that contacts the top of the cartridge retention portion of the main body, and recesses on the interior sides to receive projections on the main body for a friction fit to secure the cover on the main body when fully installed.

### BRIEF DESCRIPTION OF THE DRAWINGS

The present invention will be better understood when considered in view of the attached drawings, in which like reference characters indicate like parts. The drawings, however, are presented merely to illustrate a preferred embodiment of the invention without limiting the invention in any manner whatsoever.

FIG. 1 is a side view of the dermaplane razor according to the present invention.

FIG. 2 is a side view of the dermaplane razor with a cover installed over the blade of the cartridge.

FIG. 3 is a perspective view of the dermaplane razor with the blade cartridge partially removed.

FIG. 4 is a perspective view of the dermaplane razor with the cover partially installed.

FIG. 5 is an exploded perspective view of the dermaplane razor and cover.

FIG. 6 is an exploded perspective view of the non-slip outer sleeve over a portion of the handle of the main body of the dermaplane razor.

FIG. 7 is a partially exploded perspective view of the non-slip grip pad over a portion of the main body of the dermaplane razor.

FIG. 8 is a side, cross sectional and detailed view of the non-slip outer sleeve on the handle portion of the main body.

FIG. 9 is a top, cross sectional and detailed view of the non-slip grip pad on the main body.

FIG. 10 is a side elevation of the blade cartridge according to the present invention.

FIG. 11 is a side elevation of the blade cartridge partially inserted into the cartridge retention portion of the main body.

FIG. 12 is a side elevation of the blade cartridge fully inserted into the cartridge retention portion of the main body.

FIG. 13 is a cross sectional front elevation of the blade cartridge inserted into the cartridge retention portion of the main body.

### DETAILED DESCRIPTION OF THE PREFERRED EMBODIMENT

The following description of the preferred embodiment is presented to describe the present invention without limiting the scope of the invention.

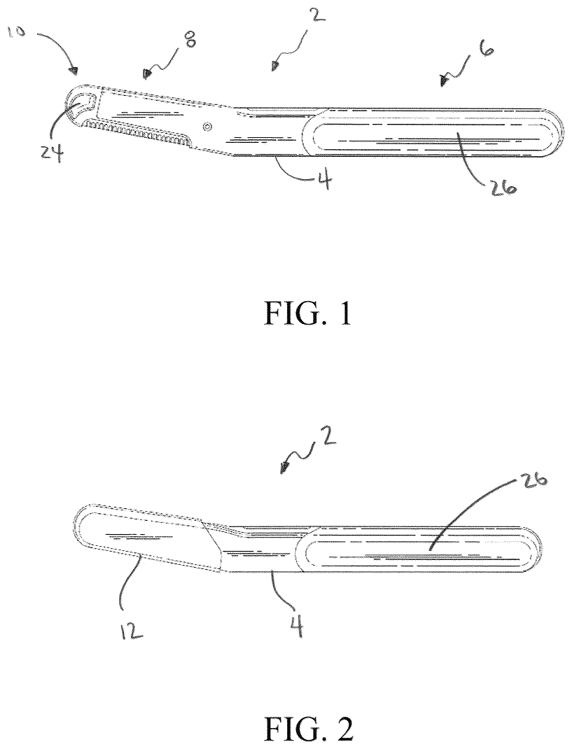

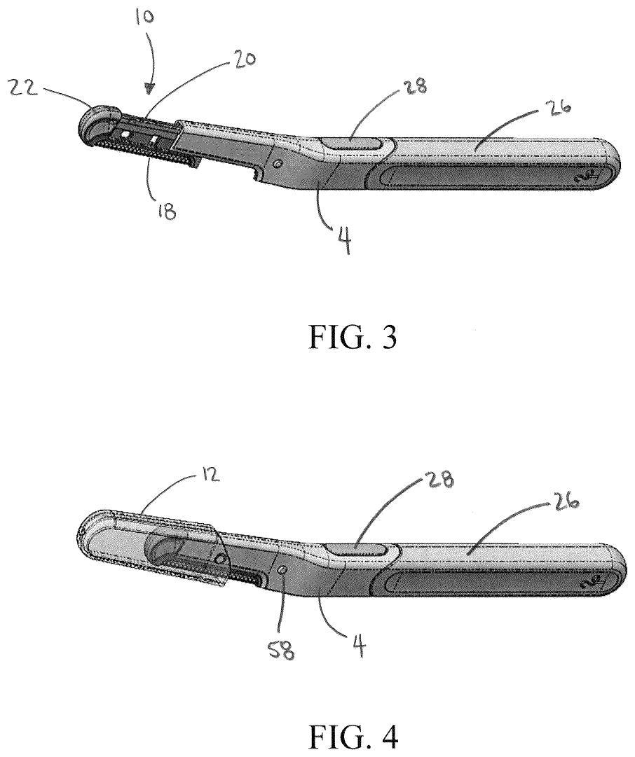

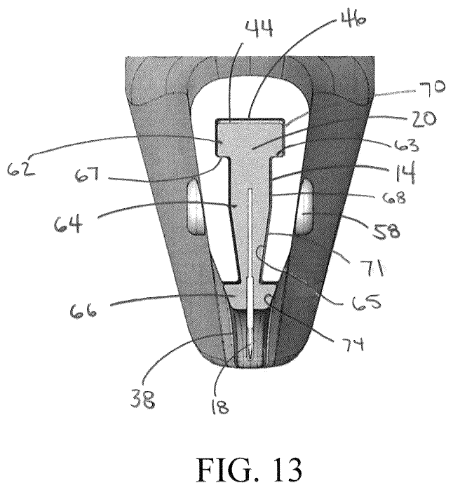

The present invention, as shown in FIGS. 1-4, is directed to a non-disposable dermaplane razor 2 comprising a main body 4, including a handle portion 6 and a cartridge retention portion 8, a replaceable blade cartridge 10, and a removable cover 12. The cartridge retention portion 8 of the main body 4 comprises a cartridge opening 14 extending longitudinally inward from a front face 16 of the cartridge retention portion 8 to receive the blade cartridge 10, including a slot 17 (shown in FIG. 13) through which a portion of the cartridge 10 holding the blade 18 passes.

The blade cartridge 10 comprises a blade 18 fixed within a quasi-triangular I-shaped spine 20, the spine 20 comprising a horizontal top portion 62, a vertical middle portion 64 and a horizontal bottom portion 66 when the cutting edge 52 of the blade 18 is facing downward. The spine 20 includes a detent 44 on the top surface of the top portion 62 for friction engagement with the interior top of the cartridge opening 14 when the cartridge 10 is fully inserted into the cartridge opening 14 of the main body 4.

The spine 20 terminates in a graspable end 22, preferably having a recess 24 on one or both of the sides of the graspable end 22 to be engaged by the user's fingers for removal of the cartridge 10 from the main body 4 when replacing the cartridge 10. The graspable end 22 is larger than the spine 20, providing a stop surface 23 which rests against the front face 16 of the cartridge retention portion 8.

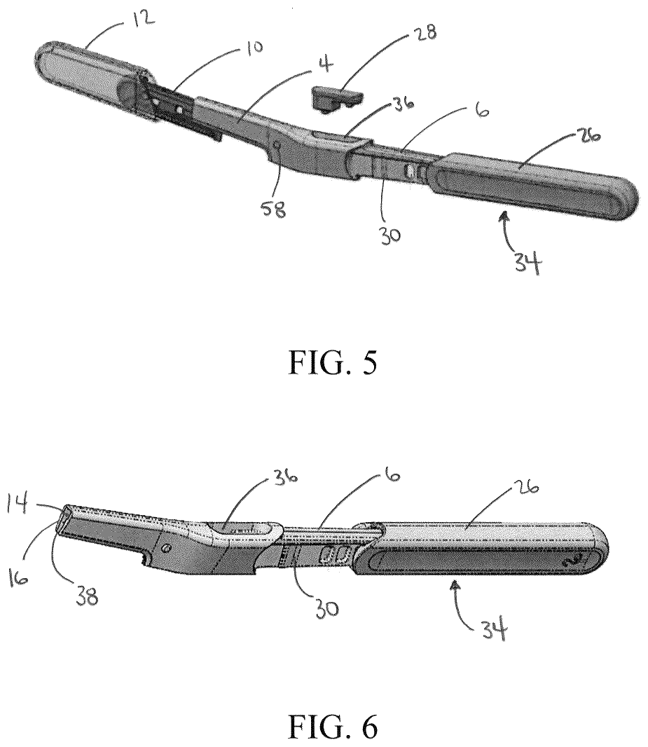

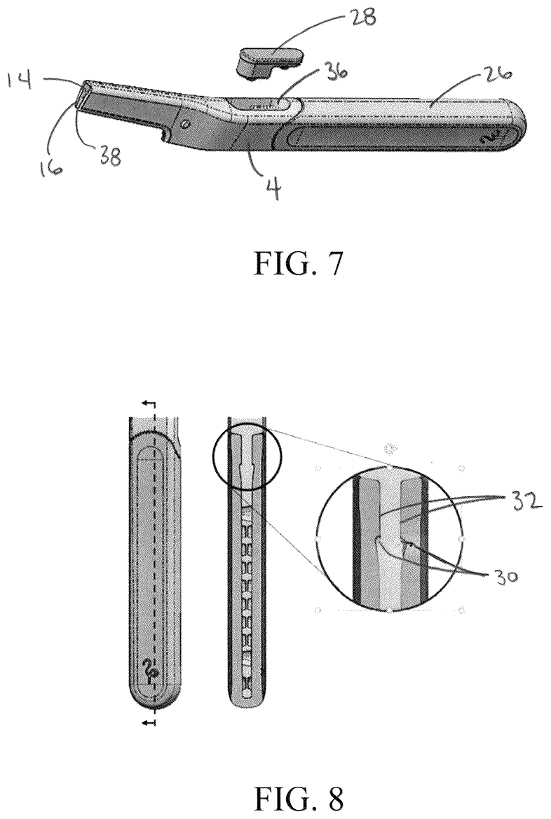

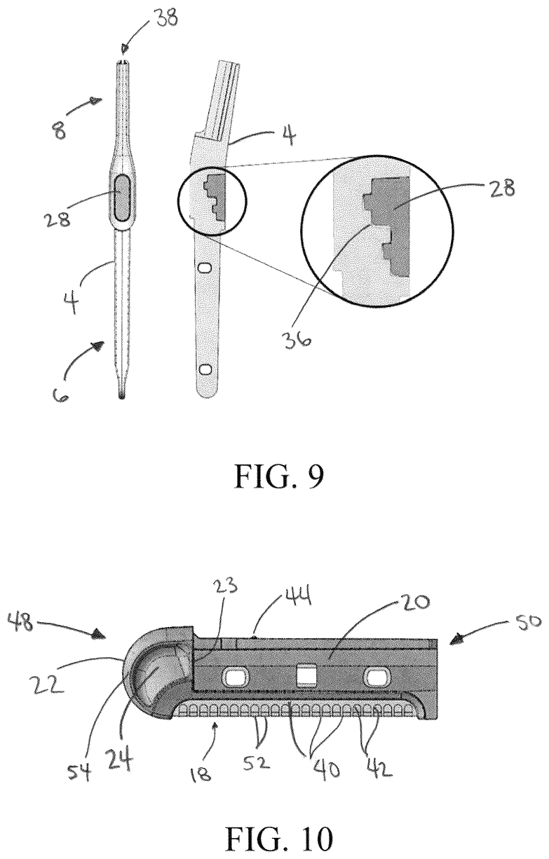

As shown in FIGS. 5-9, the main body 4 preferably comprises a non-slip outer surface 26 on at least a portion of the handle portion 6 and a non-slip grip pad 28 on a top edge of the main body 4 for improved control of the dermaplane razor 2. The non-slip outer surface 26 and grip pad 28 are preferably formed of a thermoplastic elastomer such as silicone, most preferably silicone 70A, designed to limit the dermaplane razor 2 from slipping in the user's hand during use.

The main body 4 is a diecast part running from the handle portion 6 to the cartridge retention portion 8, with the cartridge retention portion 8 extending at an obtuse angle from the handle portion 6 for ease of use. The diecast main body 4 is preferably cast from a plastic, such as a polypropylene, most preferably PP M800E, which is chrome-plated for aesthetics. The handle portion 6 of the diecast main body includes friction features 30 for engaging internal surface features 32 of an outer sleeve 34 that includes the non-slip outer surface 26.

The preferred outer sleeve 34 is molded entirely from a non-slip material, and preferably a thermoplastic elastomer such as silicone, most preferably silicone 70A. The internal surface features 32 on the internal surface of the sleeve 34 engage the friction features 30 on the handle portion 6 of the main body 4, thereby ensuring the outer sleeve 34 is securely attached to the main body 4.

The grip pad 28 of the preferred embodiment shown in the is located on a top surface of the main body 4, in the area on the handle portion 6 adjacent the angle between the handle portion 6 and the cartridge retention portion 8. It is preferred that the grip pad 28 be formed of a different material than the main body 4, and most preferably in a different color, to provide a visual and tactile cue, prompting the user on how to hold the dermaplane razor 2 during use.

As shown in FIGS. 5-7 and 9, the main body 4 comprises an aperture 36, for receiving a grip pad 28 formed of a material different than the main body, preferably a TPE such as silicone, most preferably silicone 70A. The preferred grip pad 28 is then press fit into the aperture 36. In the preferred embodiment, the top surface of the grip pad 28 is even with the top surface of the main body 4, to provide a smooth top surface, although a grip pad 28 comprising an indentation or projection could be used.

The cartridge opening 14 at the front face 16 of the cartridge retention portion 8 which receives the cartridge 10 preferably comprises a quasi-triangular T-shape, having a horizontal upper portion 68 and a vertical stem portion 70, the vertical stem portion having an inward angle 71 as it extends downwardly. The bottom of the T-shape of the opening 14 comprises an open slot 38 along at least a portion of the bottom of the cartridge retention portion 8, through which a portion of the cartridge 10 comprising the blade 18 extends.

In the preferred embodiment shown, at least a portion of the I-shape of the cartridge 10 is thicker at the top and thinner at the bottom where the blade 18 projects. As shown in FIG. 13, at least a portion of the vertical middle portion 64 of the I-shape spine 20 includes an inward angle 65 as it extends downwardly, corresponding to the inward angle 71 of the stem 70 of the T-shape opening 14. Moreover, the sides 74 of the horizontal bottom portion 66 of the I-shape of the spine 20 angle inward toward the bottom of the I-shape of the spine 20 from which the blade 18 extends.

The top portion 62 and middle portion 64 of the quasi-triangular I-shape of the cartridge 10 correspond to the quasi-triangular stem 70 of the T-shape of the cartridge opening 14, with a tight clearance along the full length of the cartridge 10, to provide stability during use. The preferred cartridge retention portion 8/cartridge opening 14 and the preferred cartridge 10 cross-sections are thinner near the slot 38 for the user to position the blade 18 closer to the skin, and thicker away from the slot 38 to provide structural support for the cartridge 10 in the cartridge opening 14.

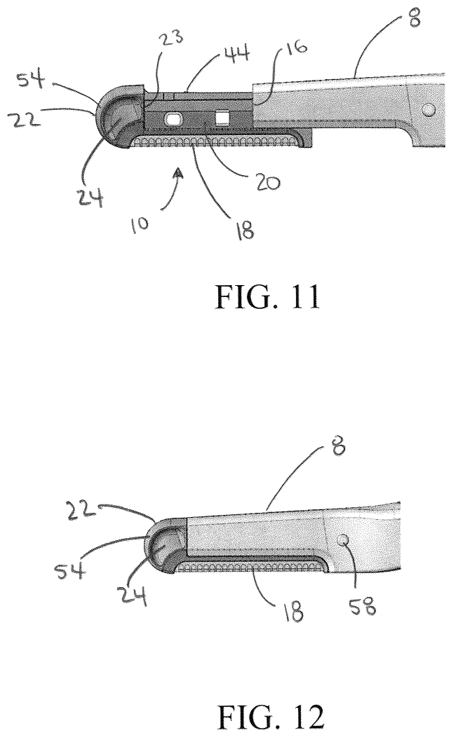

FIGS. 10-12 show a blade guard 40 formed over the cutting edge 52 of the blade 18, preferably comprising scalloped openings 42, to improve safety when using the dermaplane razor 2. The blade 18 with the blade guard 40 is preferably molded into the spine 20 using an insert molding process, where the spine 20 is preferably made of a plastic, such as a polypropylene, most preferably PP M800E.

The top of the spine 20 includes an interference detent 44 to provide a friction hold when the cartridge 10 is fully inserted within the cartridge opening 14 of the main body 4. The detent 44 is compressed against the top 46 of the cartridge opening 14, placing downward pressure on the cartridge spine 20 when fully inserted. This forces the bottoms 63 of the top portion 62 of the I-shape surfaces of the spine 20 into tight contact with the corresponding undersides 67 of the upper portion 68 of the T-shape surfaces of the cartridge opening 14, as well as forcing the corresponding inwardly angled portions 65 of the vertical portion 64 of the I-shape spine 20 into tight contact with the inwardly angled portions 73 of the stem 70 of the T-shaped opening 14, to provide a secure retention of the cartridge 10 in the cartridge opening 14 during use.

The spine 20 preferably terminates at a graspable end 48, opposite an insertion end 50 of the cartridge 10, for removal of the cartridge 10 from the main body 4. The graspable end 48 is formed integrally with the spine 20, and comprises recesses 24 on each side for engagement by the during removal of the cartridge 10. The recesses 24 are generally set in from at least a terminal end 54 of the graspable end 48, the transition from the recesses 24 to the terminal ends 54 providing a dimensional change which allows the user pull the cartridge 10 from the main body 4 without putting their hands too close to the blade 18.

The detent 44 is located closer to the graspable end 48 than the insertion end 50 of the cartridge 10, so that it engages the top surface 46 of the cartridge opening 14 when the cartridge 10 is almost fully inserted. This provides that the user will not feel an interference until the cartridge 10 is almost fully inserted into the main body 4.

A removable cover 12 protects the blade 18 and user during storage and transportation of the dermaplane razor 2, as shown in FIG. 2. The cover 12 is preferably made of a plastic, such as a polypropylene, most preferably PP M800E, and is formed as a sleeve with a closed end which encloses the entire blade 18 of the cartridge 10 and a majority of the end of the cartridge connection portion 8. The main body 4 includes projections 58 on the sides of the cartridge connection portion 8 which are engaged by depressions on the interior side surfaces of the cover 12 to securely hold the cover 12 on the dermaplane razor 2 when not in use.

The term “comprising” as used in the following claims is an open-ended transitional term that is intended to include additional elements not specifically recited in the claims. It is also noted that any feature or element positively identified in this document may also be specifically excluded as a feature or element of an embodiment of the present invention.

While certain exemplary embodiments have been described and shown in the accompanying drawings, it is to be understood that such embodiments are merely illustrative and do not limit the current invention. Accordingly, this invention is not restricted to the specific constructions and arrangements shown and described since variation, modification, and/or alternatives can occur to those of ordinary skill in the art. All such variations, modifications and/or alternatives are intended to fall within the scope of the present invention.

1. A non-disposable dermaplane razor comprising a main body having a handle portion and a cartridge retention portion, the cartridge retention portion comprising a cartridge opening at a front face, and a replaceable blade cartridge comprising a blade and a spine, wherein the spine of the cartridge comprises an I-shape, the I-shape comprising a horizontal top portion, a vertical middle portion and a horizontal bottom portion from which the blade extends downwardly when the cutting edge of the blade is facing downward, and the cartridge opening comprising a T-shape terminating at the bottom in an open slot, the T-shape comprising a horizontal upper portion and a vertical stem portion, wherein the top portion and middle portion of the I-shape correspond with and are positioned within the upper portion and the stem portion of the T-shape, with the bottom portion of the I-shape configured to be positioned outside of the slot.

2. The non-disposable dermaplane razor of claim 1, wherein at least a portion of the stem of the T-shape opening and a corresponding vertical portion of the I-shape spine are smaller at the bottom than at the top when the cutting edge of the blade is facing downward.

3. The non-disposable dermaplane razor of claim 2, wherein the T-shape opening and corresponding I-shape spine are quasi-triangular, with at least a portion of the vertical portion of the I-shape spine and the stem of the T-shape each comprising an angle that extends inward as it extends downward.

4. The non-disposable dermaplane razor of claim 3, wherein the T-shape opening and corresponding I-shape spine are quasi-triangular, with at least a portion of the vertical portion of the I-shape spine and the stem of the T-shape each comprising an angle that extends inward as it extends downward on each side of the vertical portion of the I-shape spine and on each side of the stem of the T-shape opening.

5. The non-disposable dermaplane razor of claim 1, wherein the cartridge further comprises a detent on the top surface of the top portion of the I-shape spine.

6. The non-disposable dermaplane razor of claim 5, wherein the detent is configured to be compressible against an inner top surface of the cartridge opening to create a friction fit of the cartridge in the cartridge opening, with bottoms of the top portion of the I-shape spine pushed down against tops of undersides of the upper portion of the T-shape opening.

7. The non-disposable dermaplane razor of claim 3, wherein the cartridge further comprises a detent on the top surface of the top portion of the I-shape spine.

8. The non-disposable dermaplane razor of claim 7, wherein the detent is configured to be compressible against an inner top surface of the cartridge opening to create a friction fit of the cartridge in the cartridge opening, with the angle on the vertical portion of the I-shape spine pushed down against the angle of the stem of the T-shape opening.

9. The non-disposable dermaplane razor of claim 4, wherein the cartridge further comprises a detent on the top surface of the top portion of the I-shape spine.

10. The non-disposable dermaplane razor of claim 9, wherein the detent is configured to be compressible against an inner top surface of the cartridge opening to create a friction fit of the cartridge in the cartridge opening, with the angles on the vertical portion of the I-shape spine pushed down against the angles of the stem of the T-shape opening.

11. The non-disposable dermaplane razor of claim 1, wherein the bottom portion of the I-shape spine has sides that angle inwardly as they extend downwardly in the direction that the blade extends from the spine.

12. The non-disposable dermaplane razor of claim 1, wherein the main body further comprises a grip pad on an upper surface when the blade is facing downwardly.

13. The non-disposable dermaplane razor of claim 12, wherein the grip pad comprises at least one of a gnarled surface, a non-slip material, an indented area, and a raised area for engagement by a user's finger.

14. The non-disposable dermaplane razor of claim 12, wherein the grip pad is formed of a non-slip material press fit or molded into an aperture on the main body.

15. The non-disposable dermaplane razor of claim 1, further comprising a cover configured to protect the blade when not in use.

16. The non-disposable dermaplane razor of claim 15, wherein the main body further comprises one or more projections on the cartridge connection portion that engage one or more depressions on the interior of the cover to securely retain the cover on the main body.

17. The non-disposable dermaplane razor of claim 1, wherein the handle portion of the main body comprises a non-slip surface.

18. The non-disposable dermaplane razor of claim 17, wherein the non-slip surface comprises a sleeve configured of a non-slip material on the handle portion of the main body.

19. The non-disposable dermaplane razor of claim 1, wherein the replaceable blade cartridge further comprises a graspable end, wherein the graspable end extends beyond the front face of the cartridge retention portion and comprises one or more recesses for a user to grasp the cartridge during replacement.

20. The non-disposable dermaplane razor of claim 19, wherein the graspable end comprises a stop surface configured to abut the front face of the cartridge retention portion.
